(19) United States
(12) Patent Application Publication
(10) Pub. No.: US 2025/0273813 A1
(43) Pub. Date: Aug. 28, 2025

(54) SYSTEM AND METHOD FOR PERFORMING THERMAL MANAGEMENT

(71) Applicant: GM GLOBAL TECHNOLOGY OPERATIONS LLC, Detroit, MI (US)

(72) Inventors: SeungHwan Keum, Northville, MI (US); Ronald O. Grover, JR., Northville, MI (US); Jian Gao, Auburn Hills, MI (US); Lei Wang, Rochester Hills, MI (US); Gongshin Qi, Troy, MI (US); Ryan P. Hickey, Austin, TX (US)

(73) Assignee: GM GLOBAL TECHNOLOGY OPERATIONS LLC, Detroit, MI (US)

(21) Appl. No.: 18/588,640

(22) Filed: Feb. 27, 2024

(51) Int. Cl. H01M 50/392; B60L 50/64; H01M 10/625; H01M 50/166; H01M 50/367

(52) U.S. Cl. CPC H01M 50/392; B60L 50/64; H01M 50/166; H01M 50/367; B60L 2270/10; H01M 10/625; H01M 2220/20

(57) ABSTRACT

A battery includes a first multitude of battery cells and a second multitude of battery cells located adjacent to the first multitude of battery cells. A battery housing encloses the first multitude of battery cells and the second multitude of battery cells. A catalytic material is disposed within at least one ventilation passageway located within an interior of the battery housing.

### INTRODUCTION

The subject disclosure relates to rechargeable energy storage systems (RESS) that include a battery pack assembly having at least one ventilation passageway.

Rechargeable energy storage systems (RESS) typically include one or more battery pack assemblies having battery cells that are rechargeable. The rechargeable battery cells render them useful in various modern technical applications such as electronic devices, electric bicycles, hybrid cars, electric cars, and the like.

Battery cells may undergo unfavorable thermal propagation, where the heat generated by one of the battery cells becomes greater than the ability of the battery pack assembly to dissipate the heat to its surroundings. This can result in unfavorable temperature increases in the battery pack assembly. Thermal propagation can occur, for example, when the battery is short-circuited or damaged. The thermal propagation phenomenon in one battery cell in the battery pack assembly may trigger corresponding unfavorable thermal events in adjacent battery cells.

### SUMMARY

Disclosed herein is a battery pack assembly. The assembly includes a first multitude of battery cells and a second multitude of battery cells located adjacent to the first multitude of battery cells. A battery housing encloses the first multitude of battery cells and the second multitude of battery cells. A catalytic material is disposed within at least one ventilation passageway located within an interior of the battery housing.

Another aspect of the disclosure may include a cover plate located within the battery housing and adjacent to the first multitude of battery cells and includes a multitude of battery cells. The at least one ventilation passageway includes a channel defined by the cover plate and the catalytic material is disposed in the channel.

Another aspect of the disclosure may be where the catalytic material is disposed on a surface of the cover plate defining the channel.

Another aspect of the disclosure may be where the catalytic material includes a passageway filler of catalytic material located within the channel.

Another aspect of the disclosure may be where the channel follows a serpentine pattern.

Another aspect of the disclosure may be where the at least one ventilation passageway includes a fluid conduit having an inlet in fluid communication with an interior of the battery housing and an outlet configured to be in fluid communication with an environment surrounding the battery housing and the catalytic material is disposed within the fluid conduit.

Another aspect of the disclosure may be where the fluid conduit follows a serpentine pattern within the battery housing.

Another aspect of the disclosure may be where the ventilation passageway is at least partially defined by an interior surface of the battery housing and the catalytic material is disposed on the interior surface of the battery housing.

Another aspect of the disclosure may be where the ventilation passageway is at least partially defined by an exterior surface of the first multitude of battery cells and an exterior surface the second multitude of battery cells and the catalytic material is disposed on the exterior surface of the first multitude of battery cells and the exterior of the second multitude of battery cells.

Another aspect of the disclosure may be where the at least one ventilation passageway is at least partially defined by one of the first and second multitude of battery cells and the battery housing and the catalytic material fills the at least one ventilation passageway.

Another aspect of the disclosure may be where the catalytic material is located on a surface of a passageway filler within the at least one ventilation passageway.

Another aspect of the disclosure may be where the first multitude of battery cells and the second multitude of battery cells include each cylindrically wrapped battery cells and the at least one ventilation passageway is located within an outer casing of each of the cylindrically wrapped battery cells.

Another aspect of the disclosure may be where the ventilation passage is located within at least one of a first distal end, a second distal end, or a cylindrical wall of each of the cylindrically wrapped battery cells.

Another aspect of the disclosure may include oxygen storage material located in the at least one ventilation passageway.

Another aspect of the disclosure may be where the catalytic material includes a first catalytic material and a second catalytic material, wherein the first catalytic material is different from the second catalytic material.

Another aspect of the disclosure may be where the first catalytic material includes a hopcalite and the second catalytic material includes an activated carbon.

Disclosed herein is a vehicle system. The system includes a vehicle body at least partially defining a passenger compartment and a multitude of road wheels rotatably attached to the vehicle body. A traction motor is configured to drive at least one road wheel of the multitude of road wheels attached to the vehicle body and a traction battery in electrical communication with the traction motor for providing power to the traction motor. The traction battery includes at least one battery pack assembly having a first multitude of battery cells and a second multitude of battery cells located adjacent to the first multitude of battery cells. A battery housing encloses the first multitude of battery cells and the second multitude of battery cells and a catalytic material is disposed within at least one ventilation passageway located within an interior of the battery housing.

Disclosed herein is a method of assembling a battery pack assembly. The method includes positioning at least one multitude of battery cells within a battery housing with at least one ventilation passageway located within the battery housing and adjacent the at least one multitude of battery cells. The method also includes disposing at least one catalytic material within the at least one ventilation passageway. The at least one catalytic material is disposed on at least one of a surface of the ventilation passageway or within a passageway filler located within the at least one ventilation passageway.

### BRIEF DESCRIPTION OF THE DRAWINGS

Other features, advantages and details appear, by way of example only, in the following detailed description, the detailed description referring to the drawings in which:

FIG. 1 is a schematic illustration of a vehicle including a rechargeable energy storage system (RESS).

FIG. 2 is a schematic illustration of a cross-sectional view taken along line 2-2 of FIG. 1 showing a battery pack assembly having a plurality of battery cells in the rechargeable energy storage system.

FIG. 3 is a schematic illustration of a cross-sectional view taken along line 3-3 of FIG. 2 illustrating an example ventilation passageway in a cover plate of the battery pack assembly.

FIG. 4 is a schematic illustration of another example cover plate positioned relative to a battery housing.

FIG. 5 is a schematic illustration of a fluid conduit positioned relative to a battery housing.

FIG. 6 is a schematic illustration of a cross-sectional of another example battery pack assembly.

FIG. 7 is a schematic illustration of a cross-sectional view taken along line 7-7 of FIG. 6.

FIG. 8 is a schematic illustration of another example battery cell.

FIG. 9 illustrates a method of assembling a battery pack assembly.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible to embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly outlined in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive. The words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function can perform the specified function without alteration, rather than merely having the potential to perform the specified function after further modification. In other words, the described hardware, when expressly configured to perform the specified function, is specifically selected, created, implemented, utilized, programmed, and/or designed to perform the specified function.

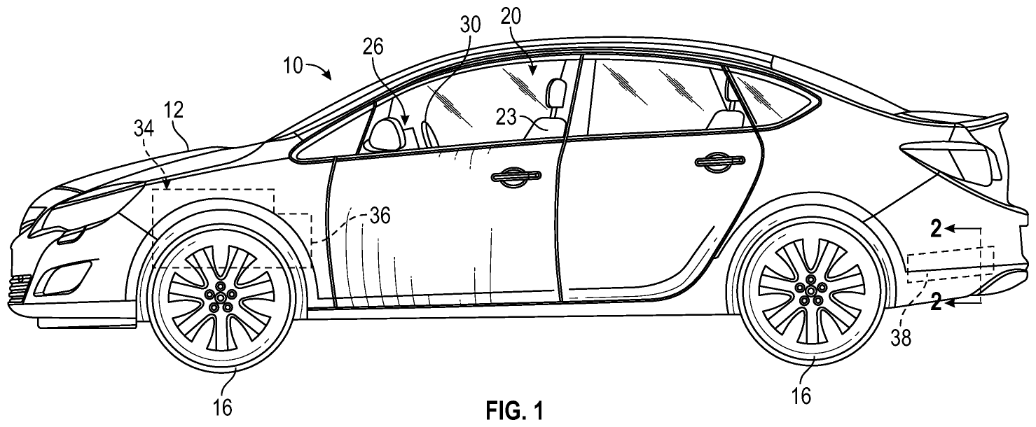

Referring now to the drawings, wherein like numerals indicate like parts in several views, a vehicle, in accordance with a non-limiting example, is indicated generally at 10 in FIG. 1. Vehicle 10 includes a body 12 supported on a plurality of wheels 16. One or more of the plurality of wheels 16 are steerable. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

Vehicle 10 includes an electric motor 34 connected to a transmission 36 that provides power to one or more of the plurality of wheels 16. A rechargeable energy storage system (RESS) 38 may include a traction battery and is arranged in the body 12 and provides power to the electric motor 34, such as a traction motor. At this point, it should be understood that the location of electric motor 34, transmission 36, and RESS 38 in body 12 may vary.

In this disclosure, the RESS 38 for the vehicle 10 includes thermal propagation mitigation and a method of assembling a battery pack assembly 50 for the RESS with thermal management, are shown and described herein.

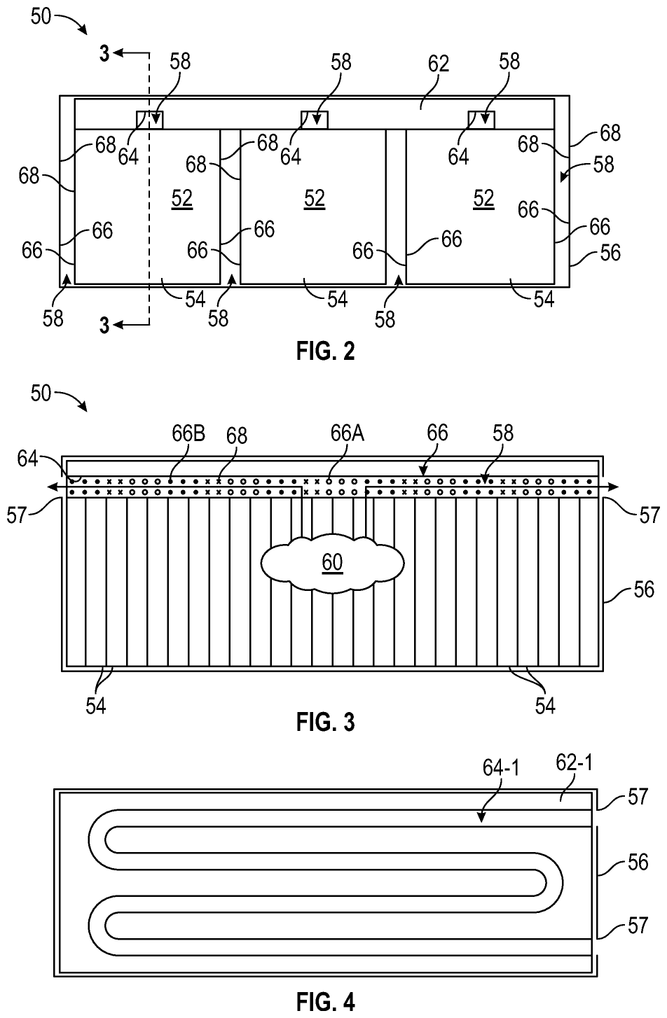

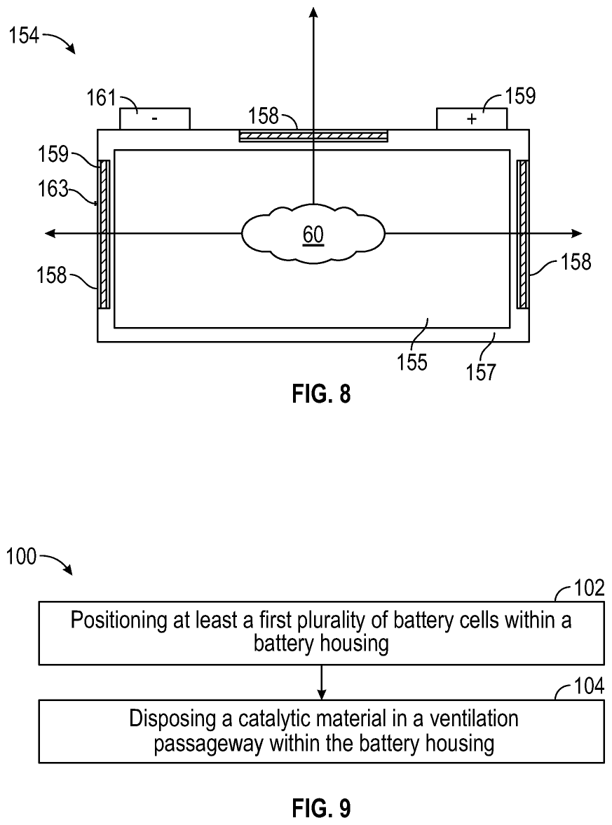

FIGS. 2-3 illustrate an example battery pack assembly 50 that forms a portion of the RESS 38. In the illustrated example, the battery pack assembly 50 includes multiple battery arrays 52 formed from a multitude of individual battery cells 54, such as lithium-ion battery cells, which are arranged within and enclosed by a battery housing 56. The battery cells 54 may be employed to store and release electric power that may be employed by an electric circuit or an electric machine, such as the electric motor 34, to perform work, such as for communications, display, or propulsion of the vehicle 10. As shown in FIG. 2, the battery cells 54 include individual pack style battery cells that are generally rectangular and arranged linearly into three battery arrays 52, however, cylindrically wrapped or jelly roll style battery cells 154 as shown in FIG. 8 can benefit from this disclosure as will be discussed in greater detail below.

The individual cylindrically wrapped battery cells 54 can generate heat while converting electric power to chemical potential energy, i.e., battery charging, and converting chemical potential energy to electric power, i.e., battery discharging. Exposure of an individual battery cell 54 to elevated temperatures over prolonged periods of time may cause the individual battery cell 54 to experience thermal propagation, i.e., an uncontrolled increase in temperature within the individual battery cell 54, which may lead to thermal propagation in adjacent battery cells 54 within the battery pack assembly 50. During thermal propagation, the generation of heat within an individual battery cell or RESS exceeds the ability to dissipate heat, thus leading to a further increase in temperature of the battery pack assembly 50.

The battery pack assembly 50 can include multiple ventilation passageways 58 located within the battery housing 56. The ventilation passageways 58 provide a pathway for the gases 60, such as high temperature and high pressure gases, which may form during thermal propagation in the individual battery cells 54 to reach an environment surrounding the battery housing 56. In the illustrated example, the ventilation passageways 58 may include channels 64 defined by a cover plate 62. The cover plate 62 may be located between the battery arrays 52 and a portion of the battery housing 56 with channels 64 corresponding to each of the battery arrays 52 and extending a length of each of the battery arrays 52. In one example, the cover plate 62 may be comprised of a metallic material, such as steel, which is formed through a machining or stamping process. In another example, the cover plate 62 may be comprised of a mica thermal insulator.

In addition to providing a flow path for the gases 60 to leave the interior of the battery housing 56, the ventilation passageways 58 can also include one or more catalytic materials 66 that function as a catalytic converter for treating the gases 60 that form in the battery cells 54 when approaching thermal propagation. Furthermore, the ventilation passageways 58 may include oxygen storage materials 68 to aid the catalyst materials 66 in oxidizing the gases 60 before leaving the battery housing 56. In one example, the gases 60 that are generated by the battery cells 54 when approaching thermal propagation may include one or more of carbon-monoxide (CO), hydrogen gas (H₂), or volatile organic compounds (VOCs).

As shown in FIG. 3, the channel 64 forming a portion of the ventilation passageway 58 includes a surface coating of the catalytic materials 66 and the oxygen storage materials 68. The surface coating may include multiple layers or types of catalytic materials 66, such as a first catalytic material 66A and a second catalytic material 66B, in connection with the oxygen storage materials 68 to treat the gases 60 formed by the battery cells 54. For example, at least three and up to five different catalytic materials may be used depending on the potential types of gases 60 formed by the battery cells 54 during thermal propagation. In one example, the catalytic materials 66 can include one or more of hopcalite, platinum, palladium, copper, or activated carbon and the oxygen storage material 68 can include cerium dioxide (Ce0₂). In one example, the catalytic reaction of the catalytic materials 66 and the oxygen storage materials 68 can convert the gases 60 to carbon dioxide (C0₂) and water (H₂0).

As shown in FIG. 3, the catalytic materials 66 and the oxygen storage material 68 can be disposed directly onto a surface of the channel 64 in the cover plate 62 to form layers of catalytic material 66 and the oxygen storage material 68 on a surface of the channel 64. Alternatively, each of the catalytic materials 66 and oxygen storage materials 68 can be disposed on adjacent longitudinal segments of the surface of the channel 64, such as a longitudinal segment relative to a length of the channel 64. In the illustrated example, the channels 64 include outlets that are aligned with a corresponding housing outlet 57 that allows channel 64 to be in fluid communication with the environment surrounding the battery housing 56.

In addition to the ventilation passageway 58 defined by the channel 64 in the cover plate 62, other ventilation passageways 58, such one defined between the battery arrays 52 and the battery housing 56 or between the adjacent battery arrays 52, can be located in the battery housing 56 and provide a pathway for the gases 60 to travel once formed. These additional ventilation passageways 58 can also include the catalytic materials 66 and the oxygen storage materials 68 applied to at least one surface of these ventilation passageways 58. One feature of these additional ventilation passageways is that they may include a larger surface area to interact with and convert the gases 60 before leaving the battery housing 56.

For the example of the ventilation passageway 58 located between the battery housing 56 and an adjacent battery array 52, the catalytic materials 66 and oxygen storage materials 68 may be disposed on an interior surface of the battery housing 56 with or without these materials also located on an exterior surface of the battery array 52 that faces the battery housing 56 across the ventilation passageway 58. Furthermore, when the ventilation passageway 58 is between adjacent battery arrays 52, surfaces of the battery arrays 52 facing across the ventilation passageway 58 may have the materials 66 and 68 disposed thereon. Alternatively, an exterior surface of each battery cell 54 facing an adjacent battery array 52, the battery housing 56, or the cover plate 62 can be coated in a combination of the catalytic materials 66 and the oxygen storage materials 68.

FIG. 4 illustrates another example cover plate 62-1. The cover plate 62-1 is similar to the cover plate 62 except where described below or shown in the drawings. Like numbers will identify similar or identical components with the addition of a trailing “1.”

As illustrated, the cover plate 62-1 is located within a portion of the battery housing 56 and includes a channel 64-1 that follows a serpentine pattern with four longitudinal sections connected by one of three corresponding bends. One feature of this configuration is that it provides a channel 64-1 with an increased length. The increased length of the channel 64 can provide increased contact for the gases 60 to travel with the catalytic materials 66 and oxygen storage materials 68 for treatment before leaving the battery housing 56.

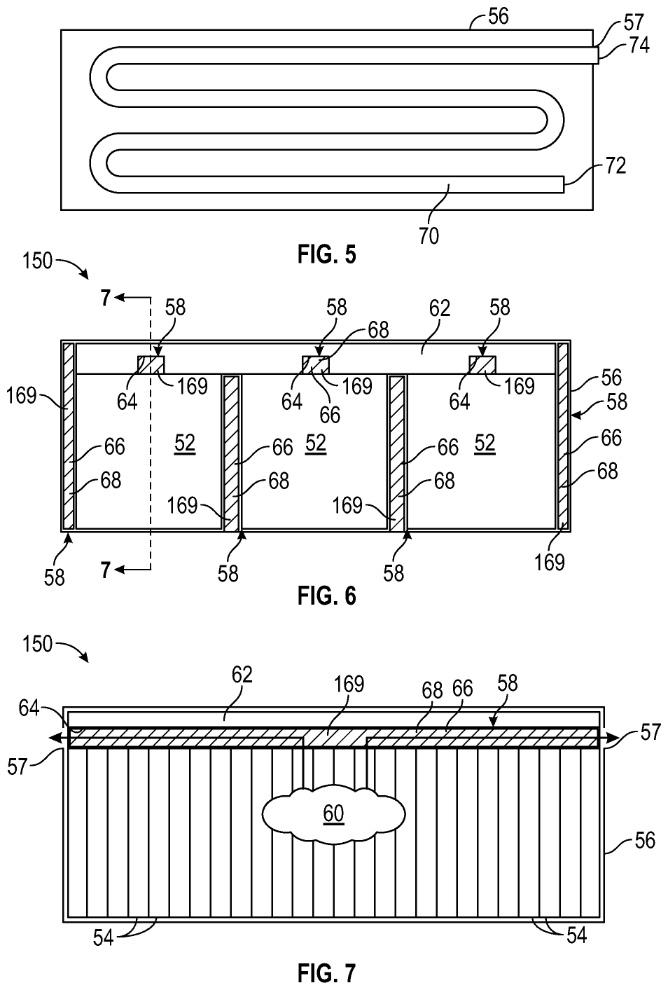

FIG. 5 illustrates a fluid conduit 70 that may be used in place of or in addition to one of the cover plates 62 and 62-1 illustrated in FIGS. 2-4. As shown in FIG. 5, the fluid conduit 70 follows a serpentine pattern and is located within the battery housing 56. An inner surface of the fluid conduit 70 is coated with a combination of the catalytic materials 66 and the oxygen storage materials 68. The fluid conduit 70 includes a fluid inlet 72 located at a first end that is in fluid communication with an interior space of the battery housing 56 and a fluid outlet 74 that passes through one of the housing outlets 57 to allow the gases 60 to reach the surrounding environment of the battery housing 56. One feature of fluid conduit 70 is that it provides a fluid passageway for the gases 60 with an increased length to facilitate greater conversion by the combination of the catalytic materials 66 and oxygen storage materials 68 that are disposed within the fluid conduit 70.

FIGS. 6 and 7 illustrate another example battery pack assembly 150. The battery pack assembly 150 is similar to the battery pack assembly 50 except where described below or shown in the drawings. Reference numbers for similar components from the battery pack assembly 150 will include the addition of a leading 1 to the components from the battery pack assembly 50 and like components will use the same reference numbers.

The battery pack assembly 150 includes multiple ventilation passageways 58 located within the battery housing 56 for providing a pathway for the gases 60 that may form during thermal propagation of one or more of the battery cells 54. The ventilation passageways 58 provide a fluid path for high-pressure gases 60 to reach an environment surrounding the battery housing 56 to reduce the pressure within the battery housing 56. While the ventilation passageways 58 in the battery pack assembly 50 included catalytic materials 66 and oxygen storage material 68 located on surfaces of various components adjacent the ventilation passageways 58, the battery pack assembly 150 includes the catalyst materials 66 and oxygen storage materials 68 disposed within a passageway filler 169 located within the ventilation passageways 58.

In one example, the passageway filler 169 includes a mixture of one or more catalytic materials 66 and the oxygen storage material 68. One feature of the passageway filler 169 can include a packed bed and provides an increase in surface area for the gases 60 to contact while traveling through the ventilation passageways 58 in the battery pack assembly 150. In another example, the passageway filler 169 includes a monolithic structure having a multitude of channels that are each covered by the catalytic materials 66 and the oxygen storage materials 68. The multitude of channels in the monolithic structure provide increased surface area for the gases 60 to interact with for conversion into another type of gas prior to exiting the battery housing 56.

FIG. 8 illustrates another example battery cell 154 for use in either the battery pack assembly 50 or 150. In the illustrated example, the battery cell 154 is a cylindrical or jelly roll style battery cell. The battery cell 154 can be lithium-ion based and include multiple battery layers 155 that are rolled together and placed within an outer casing 157, such as a housing comprised of aluminum, which encapsulates the battery layers 155. The battery cell 154 also includes a positive terminal 159 and a negative terminal 161 that can each be connected in series with other battery cells 154 within the battery pack assemblies 50 or 150.

In the illustrated example, the outer casing 157 includes multiple ventilation passageways 158 defined by a portion of the outer casing 157. The ventilation passageways 158 define fluid passages between an interior of the battery cell 154 wherein the battery layers 155 can generate the gases 60 as described above with an environment surrounding the battery cell 154. When the battery cells 154 are used with one of the battery pack assemblies 50 or 150, the surrounding environment would include an interior of the battery housing 56. A combination of the catalytic materials 66 and the oxygen storage materials 68 can be disposed on a surface of the ventilation passageways 158 as described above with respect to FIGS. 1-5. Alternatively, the ventilation passageways 158 can utilize the passageway filler 169 as described above in FIGS. 6-7. When utilizing the passageway filler 169 within the ventilation passageways 158, the outer casing 157 may include a retention tab 163 that retains the passageway filler 169 or an adhesive to retain the passageway filler 169 in the ventilation passageway 158 during assembly of the battery cell 154. One feature of this configuration is the ability for the gases 60 to be treated prior to leaving the battery cell 154 and entering the interior space of the battery housing 56. The gases leaving the battery housing 56 can then be further treated as described above if desired.

FIG. 9 illustrates a method 100 of assembling one of the battery pack assemblies 50 or 150. The method 100 includes positioning at least one plurality of battery cells 54 or 154 within the battery housing 56 at Block 102. The battery cells 54 or 154 are positioned within the battery housing 56 to allow for at least one ventilation passageway 58 to be located within the battery housing 56 and adjacent to the plurality of battery cells 54 or 154.

At least one catalytic material 66 is disposed within the at least one ventilation passageway 58 at Block 104. The oxygen storage material 68 can also be disposed within the ventilation passageway 58. The at least one catalytic material 66 and the oxygen storage material 68 can be disposed on at least one of a surface of the ventilation passageway 58 or within a passageway filler located within the at least one ventilation passageway 58. One feature of locating the catalytic materials 66 and oxygen storage materials 68 within the ventilation passageways 58 is a conversion of a high exothermic potential of the gases 60 to a lower exothermic potential prior to exiting the battery pack assembly 50 and 150. The exothermic potential is converted via a catalytic oxidation prior to the gases 60 being expelled from the battery housing 56 to the external environment.

Furthermore, the ventilation passageways 58 can be optimized to provide a desired residence time for the gases 60 through the catalytic material 66 and oxygen storage material 68 prior to the gases 60 being expelled from the battery pack assembly 50 or 150 to the external environment. The catalytic conversion can be optimized to maximize exothermic potential reduction of the gases.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure not be limited to the particular embodiments disclosed but will include embodiments falling within the scope thereof.

What is claimed is:

1. A battery pack assembly, comprising:
a first plurality of battery cells;
a second plurality of battery cells located adjacent to the first plurality of battery cells;
a battery housing enclosing the first plurality of battery cells and the second plurality of battery cells; and
a catalytic material disposed within at least one ventilation passageway located within an interior of the battery housing.

2. The battery pack assembly of claim 1, including a cover plate located within the battery housing and adjacent to the first plurality of battery cells and includes a plurality of battery cells, wherein the at least one ventilation passageway includes a channel defined by the cover plate and the catalytic material is disposed in the channel.

3. The battery pack assembly of claim 2, wherein the catalytic material is disposed on a surface of the cover plate defining the channel.

4. The battery pack assembly of claim 2, wherein the catalytic material includes a passageway filler of catalytic material located within the channel.

5. The battery pack assembly of claim 2, wherein the channel follows a serpentine pattern.

6. The battery pack assembly of claim 1, wherein the at least one ventilation passageway includes a fluid conduit having an inlet in fluid communication with an interior of the battery housing and an outlet configured to be in fluid communication with an environment surrounding the battery housing and the catalytic material is disposed within the fluid conduit.

7. The battery pack assembly of claim 6, wherein the fluid conduit follows a serpentine pattern within the battery housing.

8. The battery pack assembly of claim 1, wherein the ventilation passageway is at least partially defined by an interior surface of the battery housing and the catalytic material is disposed on the interior surface of the battery housing.

9. The battery pack assembly of claim 1, wherein the ventilation passageway is at least partially defined by an exterior surface of the first plurality of battery cells and an exterior surface the second plurality of battery cells and the catalytic material is disposed on the exterior surface of the first plurality of battery cells and the exterior of the second plurality of battery cells.

10. The battery pack assembly of claim 1, wherein the at least one ventilation passageway is at least partially defined by one of the first and second plurality of battery cells and the battery housing and the catalytic material fills the at least one ventilation passageway.

11. The battery pack assembly of claim 1, wherein the catalytic material is located on a surface of a passageway filler within the at least one ventilation passageway.

12. The battery pack assembly of claim 1, wherein the first plurality of battery cells and the second plurality of battery cells include each cylindrically wrapped battery cells and the at least one ventilation passageway is located within an outer casing of each of the cylindrically wrapped battery cells.

13. The battery pack assembly of claim 12, wherein the ventilation passage is located within at least one of a first distal end, a second distal end, or a cylindrical wall of each of the cylindrically wrapped battery cells.

14. The battery pack assembly of claim 1, including oxygen storage material located in the at least one ventilation passageway.

15. The battery pack assembly of claim 1, wherein the catalytic material includes a first catalytic material and a second catalytic material, wherein the first catalytic material is different from the second catalytic material.

16. The battery pack assembly of claim 15, wherein the first catalytic material includes a hopcalite and the second catalytic material includes an activated carbon.

17. A vehicle system, comprising:
a vehicle body at least partially defining a passenger compartment;
a plurality of road wheels rotatably attached to the vehicle body;
a traction motor configured to drive at least one road wheel of the plurality of road wheels attached to the vehicle body; and
a traction battery in electrical communication with the traction motor for providing power to the traction motor and having at least one battery pack assembly including:
a first plurality of battery cells;
a second plurality of battery cells located adjacent to the first plurality of battery cells;
a battery housing enclosing the first plurality of battery cells and the second plurality of battery cells; and
a catalytic material disposed within at least one ventilation passageway located within an interior of the battery housing.

18. The vehicle system of claim 17, including a cover plate located within the battery housing and adjacent to the first plurality of battery cells and includes a plurality of battery cells, wherein the at least one ventilation passageway includes a channel defined by the cover plate and the catalytic material is disposed in the channel.

19. The vehicle system of claim 17, wherein the first plurality of battery cells and the second plurality of battery cells include each cylindrically wrapped battery cells and the at least one ventilation passageway is located within an outer casing of each of the cylindrically wrapped battery cells.

20. A method of assembling a battery pack assembly, the method comprising:
positioning at least one plurality of battery cells within a battery housing, wherein at least one ventilation passageway is located within the battery housing and adjacent the at least one plurality of battery cells; and
disposing at least one catalytic material within the at least one ventilation passageway, wherein the at least one catalytic material is disposed on at least one of a surface of the ventilation passageway or within a passageway filler located within the at least one ventilation passageway.
